(19) United States
(12) Patent Application Publication
(10) Pub. No.: US 2022/0397129 A1
(43) Pub. Date: Dec. 15, 2022

(54) WORKING CYLINDER

(71) Applicant: BUEMACH ENGINEERING INTERNATIONAL B. V., TA Emmen (NL)

(72) Inventor: Josef Bueter, Haren/Altenberge (DE)

(21) Appl. No.: 17/775,440

(22) PCT Filed: Nov. 6, 2020
(86) PCT No.: PCT/DE2020/000270

§ 371 Date: May 9, 2022

(30) Foreign Application Priority Data
Nov. 8, 2019 (DE) 20 2019 004 568.6

(51) Int. Cl. F15B 15/14; F16J 10/02; B23K 26/282

(52) U.S. Cl. CPC F15B 15/1428; F15B 15/1438; F16J 10/02; B23K 26/282

(57) ABSTRACT

A working cylinder has a cylinder tube, a first closure part, a second closure part and a piston unit. The first closure part is arranged at a first cylinder tube end and the second closure part is arranged at a second cylinder tube end, the cylinder tube and the first and second closure parts define a cylinder interior. The piston unit defines at least one working chamber in the cylinder interior. The piston unit slidably passes through the first closure part. The first closure part us joined to the cylinder tube in a positive-locking manner by a first circumferential laser ring weld seam. The second closure part is joined to the cylinder tube in a positive-locking manner by a second circumferential laser ring weld seam, and each of the laser ring weld seams define a fluid-tight sealing plane. At least one of the closure parts has an axially opening that is a circumferential concave receiving contour in which the cylinder tube engages. The receiving contour radially overlaps the cylinder tube, and a ring weld seam inclination angle thereof is 110 to 160 degrees.

The invention relates to a welded working cylinder with increased load-bearing capacity.

In the prior art, hydraulic and pneumatic working cylinders are described in different variants.

In almost all embodiments, these working cylinders comprise a cylinder tube and closure parts.

In order to produce such working cylinders, the closure parts are coupled to the cylinder tube in different ways according to the state of the art.

Commonly, a positive-locking coupling is produced by screwing the closure parts to the cylinder tube. The working cylinders produced in this way are therefore also known as screw cylinders.

According to the prior art, it is also known to connect the bottom closure part to the cylinder tube by MAG welding first and then to screw only the guide closure part.

Screw cylinders as well as cylinders with screw connection of only one closure part and MAG welding of the other closure part are provided in high quality according to the state of the art and have proven to be first-class and reliable products.

Since the thread of the closure parts and the cylinder tube is usually formed by a machining process, an allowance of the material thickness, i.e., of the tube wall thickness, for the cylinder tube in particular, must be provided for the thread to be subtractively produced, because the thread inevitably weakens the cylinder tube. This means that the tube wall thickness is considerably overdimensioned to absorb the forces during operation, especially the forces caused by the operating pressure of the fluid. This leads to the disadvantage of increased material consumption.

In addition, the machining processes for forming the thread require a high degree of precision and are therefore very demanding to manufacture.

To ensure tightness, a seal must be regularly inserted between the cylinder tube and the respective closure part as an additional measure.

Another disadvantage is that additional means must be provided to prevent the screw connection from loosening. It is also a disadvantage that, as a result of the changing operating pressures, there are dynamic loads on the threads which limit their service life.

It is the task of the invention to provide a working cylinder which has a particularly high quality and can be manufactured in a material-saving, simple and therefore cost-effective manner.

The task is solved by the features listed in claim 1. Preferred further embodiments result from the sub-claims.

According to the invention, the basic components of a working cylinder are a cylinder tube, a first and a second closure part and a piston unit. The first closure part and the second closure part are hereinafter collectively also referred to as the closure parts.

The working cylinder according to the invention may be provided in different designs. In particular, the working cylinder may be a differential working cylinder, a plunger cylinder, a synchronized cylinder, a telescopic cylinder, a traction cylinder or also a pneumatic working cylinder. If the working cylinder is designed as a synchronized cylinder, it will also be referred to as a steering cylinder hereinafter. Working cylinders within the meaning of the present invention are further understood to be, in particular, storage cylinders, gas spring cylinders and hydraulic shock absorbers.

In particular, a working cylinder according to the invention can be designed as a double-acting or single-acting working cylinder. A differential working cylinder, for example, is a double-acting hydraulic working cylinder with two working chambers, and the piston target surfaces in the two working chambers have different sizes. Thus, forces of different magnitudes act on the piston in the two actuation directions at the same operating pressure. In contrast to a differential working cylinder, the piston rod of a synchronized cylinder is guided by guide closure parts arranged on both sides so that the effective surfaces of the piston are of the same size and, consequently, forces of the same magnitude act in both actuation directions at the same operating pressure so that synchronized cylinders are used in particular as steering cylinders. A plunger cylinder, in contrast, is a single-acting working cylinder in which the pressure medium displaces the piston as a solid body and thus causes it to move outwards. The same applies to the telescopic cylinder, in which several cylinder tubes are inserted into each other, thus enabling particularly long working movements.

According to the invention, the first closure part is arranged at the first cylinder tube end. Preferably, the first closure part is a guide closure part. A guide closure part is understood to be a closure part which receives a piston unit in a sliding and sealing manner. In a differential working cylinder, for example, the piston unit can consist of a piston and a piston rod, and the piston rod is received by the guide closure part. In a plunger cylinder, the piston unit is designed as a volume-forming piston, also referred to as a plunger piston, which is received by the guide closure part.

The first closure part is designed such that it has a contact surface which, when attached to the first cylinder tube end, rests against a corresponding further contact surface of the first cylinder tube end. These contact surfaces preferably surround the first closure part and the cylinder tube completely. This results in a continuous annular surface against which the first closure part at the first cylinder tube end rests. The annular surface is obliquely inclined so that it is a lateral truncated cone surface from a geometric point of view. For the sake of simplicity and irrespective of the geometric design, this surface will be referred to simply as an annular surface in the following.

According to the invention, the second closure part is arranged at the second cylinder tube end. The contents of the description concerning the relationship of the first closure part to the first cylinder tube end apply correspondingly to the relationship of the second closure part to the second cylinder tube end. With regard to the contact surface, the second closure part is designed analogously to the first closure part. Preferably, the second closure part is a bottom closure part, which is then axially opposite the piston of the piston unit and axially delimits the at least one working chamber of the working cylinder according to the invention.

The working cylinder according to the invention further comprises the piston unit. Depending on the type of working cylinder, the piston unit can consist of a piston and a piston rod—which is the case, for example, with a differential working cylinder or a synchronized cylinder—or only of a piston—which is the case, for example, with a plunger cylinder—or it can have other designs. If the piston unit comprises a piston and a piston rod, the piston and the piston rod have a fixed positional relationship relative to each another. Preferably, the piston and the piston rod are firmly coupled to each other. In such designs, they are preferably connected by welding in a material-bonding manner. The piston and piston rod can also be detachably coupled. In special cases, however, it is also possible that the piston unit is designed as a one-piece unit and, thus, the piston and piston rod are sections of a monolithic component.

In the assembled state, the cylinder tube and the closure parts form a cylinder interior according to the invention. If the cylinder tube and closure parts are joined together, their inside surface sections delimit the cylinder interior. And the cylinder interior extends to the respective laser ring weld seam.

Furthermore, in the working cylinder according to the invention, the piston unit forms at least one working chamber in the cylinder interior. This chamber is defined by the cylinder tube, a closure part and the piston unit. The piston unit is arranged such that it can be axially displaced, and the main longitudinal axis of the cylinder tube and the axial direction of movement of the piston unit coincide. In this design, the piston unit preferably passes, at least in sections, through the first closure part in a sliding and sealing manner. A pressure medium connection is assigned to the working chamber via which the pressure medium can enter the working chamber or be led out of it and, thus, the working chamber can be pressurized. The pressure medium can be a hydraulic or pneumatic pressure medium.

If the working cylinder according to the invention is, for example, designed as a differential working cylinder, the following applies in addition.

The piston of the piston unit is arranged in the cylinder interior and separates the cylinder interior into a piston crown working chamber, hereinafter also abbreviated to piston crown chamber in a shortening way, and a piston rod working chamber. The piston crown chamber is located between the piston and the second closure part, here designed as a bottom closure part. The piston rod working chamber is located on the side of the piston rod between the piston and the first closure part, here designed as a guide closure part. The at least one working chamber is thus the piston rod working chamber. In addition, the piston crown working chamber forms a further working chamber.

The piston can be axially displaced and arranged in the cylinder interior in such a way that the main longitudinal axes of the piston and cylinder tube overlap each other.

The pressure medium connections are provided at the cylinder such that an operating pressure can be applied to the piston crown working chamber and the piston rod working chamber.

The piston may additionally have various guide, sealing or piston rings. Various embodiments of a piston for a working cylinder are known as such from the state of the art.

According to the invention, the piston rod slidably passes through the first closure part, here designed as a guide closure part.

The piston rod is slidably supported in the guide closure part, and the guide closure part is designed such that it prevents the pressure medium, hereinafter also referred to as a fluid, from escaping. This is achieved, for example, by appropriate ring seals.

The working cylinder according to the invention is particularly characterized in that both closure parts, i.e., for example both the guide closure part and the bottom closure part in the case of a differential working cylinder, are welded to the cylinder tube.

In this case, the first closure part is joined to the cylinder tube by means of a first circumferential laser ring weld seam, and the second closure part is joined to the cylinder tube by means of a second circumferential laser ring weld seam. Hereinafter, the components connected to each other are also referred to collectively as the coupling partners.

The two closure parts are joined to the cylinder tube by laser welding. The laser ring weld seams are fusion welded joints produced without the addition of filler metals.

Advantageously, laser welding forms a very narrow, tapered weld seam. The acute angle formed by the lateral flanks of the essentially V-shaped laser weld seam is preferably less than 15 degrees and in a particularly preferred design less than 10 degrees.

The two laser ring weld seams each form a fluid-tight sealing plane. This means that the first laser ring weld seam prevents the pressure medium from passing the connection point between the cylinder tube and the first closure part, and the second ring weld seams prevents the pressure medium passage between the cylinder tube and the second closure part, and all this without the need for additional sealing means, such as a sealing ring.

The cylinder tube and closure parts as well as preferably also the piston unit are each made of a metal alloy and, particularly preferably, of a steel alloy. However, the material composition of the individual components may differ slightly. Preferably, the mass proportions of the components of the metal alloy of the cylinder differ from those of the closure parts by less than 10 weight percent. Thus, the closure parts and the cylinder tube have similar physical properties and can be welded together particularly well.

The steel alloy preferably used has a carbon content of less than 0.5 weight percent. The alloy components vanadium, chromium and manganese are preferably contained separately or in combination in a proportion from 0.01 to 2 weight percent.

The working cylinder is further characterized in that at least one closure part has an axially opening, circumferential concave receiving contour in which the cylinder tube engages, wherein the receiving contour radially overlaps the cylinder tube and the ring weld seam inclination angle alpha is 110 to 160 degrees. This oblique inclination exceeding 90 degrees is hereinafter also referred to as negative-obliquely inclined.

In the corresponding closure part, the axially opening, circumferential concave receiving contour is provided by an annular groove which has radial side walls. The radially arranged outer side wall is inclined and has a conical shape. Thus, the concave receiving contour forms a radial overlap. The radially arranged inner side wall is preferably not inclined and preferably has a cylindrical shape. So, the cross-section of the receiving contour preferably corresponds to a concave wedge. The cylinder tube is formed at the corresponding cylinder tube end such that it corresponds to the receiving contour and has an oblique annular surface relative to it, the angle of which corresponds to the inclination angle of the outer radial side wall of the receiving contour. The cross-section of the wall of the cylinder tube end thus preferably corresponds to a wedge that fits into the receiving contour.

The laser ring weld seam is arranged between the described inclined annular surfaces of the receiving contour and the cylinder tube. The inclination angle of the laser ring weld seam corresponds to the angle the inclination angle of the two inclined annular surfaces.

The welded working cylinder according to the invention has a number of considerable advantages compared to working cylinders of the prior art.

A first significant advantage is that in particular the cylinder tube requires little or no machining apart from cutting to length. In particular, threads have not to be cut or grooves to be turned. Machining of the cylinder tube is advantageously limited to the formation of the inclined front-side annular surface.

This has the direct advantage that the otherwise necessary amount of time, processing machines, tool costs and energy for machining can be saved.

Furthermore, there is the advantage of drastic material savings and thus the preservation of raw material resources because the cylinder tube has to have only about half the tube wall thickness of a screwed differential working cylinder. Allowances, for example in the tube wall thickness to compensate for the material removal for a cut thread, can be omitted.

By the omission of machining the cylinder tube and preferably also the piston rod, the quality is also significantly increased. As a result of the omission of the force input due to machining, the axial concentricity is no longer impaired. Rather, the axial concentricity of the starting products for the cylinder tubes and, if applicable, also of the piston rods is completely maintained. Consequently, the working cylinder according to the invention has a higher precision. Thus, the axial piston rod movement can also be provided without the problem of buckling of the piston rods in the end stop, which is known in the prior art. At the same time, this reduces the wear of the cylinder guides in the guide closure part. By the omission of machining the cylinder tube and, if applicable, the piston rod, reductions in the load capacity due to notch effects are also avoided.

It was found that thanks to the concave receiving contour in interaction with the ring weld seam inclination angle according to the invention, three advantageous effects are simultaneously achieved with the same means. Firstly, the radial overlap of the cylinder tube provides positive-locking absorption of buckling forces caused by the working pressure of the pressure medium. The positive-locking absorption of the radially acting buckling forces relieves the laser ring weld seam so that the material-bonding force transmission at the laser ring weld seam is practically exclusively available for axial forces. Secondly, due to the inclination, a ring weld seam depth that exceeds the cylinder tube wall thickness and thus enables a higher force transmission is achieved without additional measures. Thirdly, an assembly advantage is achieved at the same time, as the cylinder tube and the corresponding closure part centre themselves automatically during an axial feed movement.

Another advantage is the absolute tightness of the differential working cylinder at the connection points between the cylinder tube and the closure parts. In this respect, it is additionally advantageous that the tightness can be achieved without the seals otherwise required according to the state of the art. The possible omission of these components, which are prone to ageing, results not only in cost savings but also in an improvement in quality and an increase in service life. Moreover, contamination due to ageing seals is excluded.

A further advantage is the increased operational safety. An axial play between the cylinder tube and the closure parts during load changes and loosening, as it is the case with threads, are excluded. Moreover, savings resulting from the omission of otherwise necessary securing elements are advantageously achieved. Finally, the otherwise necessary, for detachable connections required securing of the actual securing elements is also omitted. According to the prior art, such securing is obtained, for example, by gluing the securing elements. The omission of gluing leads to further important advantages. Firstly, the costs for the very expensive screw locking adhesives are eliminated. Secondly, there is no need to clean the surfaces to ensure their adhesion to the screw locking adhesives, which, according to the state of the art, often requires cleaning chemicals that are hazardous to health. This eliminates the need for special measures to ensure health protection and environmental protection. Thirdly, the problem that detachable connections, even when secured by screw locking adhesives, can be subject to the risk of loosening under impact loads is overcome.

Another aspect of increased operational safety is the increased resistance to manipulation. Non-destructive interventions in the cylinder interior are excluded. Possible sources of injury in connection with improper opening or improper reassembly of a differential working cylinder by untrained personnel are eliminated.

The laser welding process only leads to highly locally restricted heating of the material in the area of the laser ring weld seams.

Thus, components with thermally sensitive materials, such as seals in particular, which would be damaged by other welding processes, can still be welded at a distance of few millimetres to the planned weld seam.

Also, scaling on the inner surface sections of the cylinder tube and the closure parts, particularly in the vicinity of the weld seams, which would otherwise occur, has to be removed with great effort according to the state of the art, is avoided.

Another advantage is the reduction of thermal stresses in the coupling partners of the welded joint, since only a relatively small amount of energy input per unit length (amount of energy related to the length of the weld seam) has to be supplied in the case of laser welding.

Further, it is advantageous that the contour, the weld seam depth and the angle of the laser ring weld seams can be determined to a large extent by the movement, the energy input per unit length and the angle of the laser beam relative to the working cylinder to be produced. Thus, the contour and angle can be specifically aligned by changing the position of the laser relative to the coupling partners.

In a first particularly preferred embodiment of the working cylinder according to the invention, the working cylinder is provided as a double-acting working cylinder, and designed as a differential working cylinder.

In this embodiment, the first closure part is designed as a guide closure part and the second closure part is designed as a bottom closure part. Therefore, the first cylinder tube end is referred to as the guide-side cylinder tube end, and the second cylinder tube end is referred to as the bottom-side cylinder tube end herein. Thus, the first laser ring weld seam is arranged between the guide closure part and the guide-side cylinder tube end, and the second laser ring weld seam is arranged between the bottom closure part and the bottom-side cylinder tube end.

In a differential working cylinder, the piston unit comprises a piston and a piston rod. With regard to the structure of the piston unit designed in this way, reference is made to the above contents of the description of the working cylinder.

The piston of the piston unit is arranged in the cylinder interior and thus separates the cylinder interior into a piston crown working chamber, hereinafter also abbreviated to piston crown chamber, and a piston rod working chamber, abbreviated to piston rod chamber. The effective area of the piston in the piston crown chamber is greater on the piston crown side of the piston than on the piston rod chamber side of the piston. Thus, a greater force acts on the piston on the piston crown side than on the piston rod side at the same pressure of the pressure medium. A force acting on the piston is transmitted from the cylinder interior to the outside by means of the piston rod, which slidably passes through the guide closure part for this purpose.

In a second particularly preferred embodiment of the working cylinder according to the invention, the working cylinder is also provided as a double-acting working cylinder; however, in this embodiment it is designed as a synchronized cylinder.

In the synchronized cylinder according to this advantageous further development, the first closure part is designed as a guide closure part, as it is the case for a differential working cylinder. In addition, and as a special feature, the second closure part is also designed as a further guide closure part. The guide closure part and the further guide closure part are hereinafter collectively also referred to as the guide closure parts. Thus, the first laser ring weld seam is arranged between the guide closure part and the first cylinder tube end, and the second laser ring weld seam is arranged between the further guide closure part and the second cylinder tube end.

In this design, the piston unit also comprises a piston and a piston rod. The piston is arranged in the cylinder interior and separates it into a first and a second piston rod working chamber. For this purpose, the piston rod projects axially over the piston on both sides and is guided out of the piston interior on both sides through the closure parts, which are both provided as guide closure parts here. Thus, the piston rod slidably passes through both guide closure parts.

Both piston rod working chambers have the same cross-section and thus the piston has effective surfaces of the same size on both sides for the pressure medium. The force acting on the piston and the length of the working stroke executed by the piston are the same in each case, regardless of whether a certain pressure flow of the pressure medium, which is the same in terms of pressure and volume, acts on the first or the second piston rod working chamber. Due to this identical behaviour in both actuation directions, the synchronized cylinder is often also used as a steering cylinder and is therefore also referred to as a steering cylinder.

According to another further development, the working cylinder is designed as a plunger cylinder. This is a single-acting working cylinder.

According to this further development, the first closure part is designed as a guide closure part, and the second closure part is designed as a bottom closure part. The first cylinder tube end is a guide-side cylinder tube end, and the second cylinder tube end is a bottom-side cylinder tube end. As it is the case with a differential working cylinder, the first laser ring weld seam is thus arranged between the guide closure part and the guide-side cylinder tube end, and the second laser ring weld seam is thus arranged between the bottom closure part and the bottom-side cylinder tube end.

The piston unit of the plunger cylinder is formed by a plunger piston. The plunger is arranged in the cylinder interior. Only one working chamber is formed in the cylinder interior. The plunger piston slidably passes through the guide closure part. When a pressure flow of the pressure medium is applied to the working chamber, the plunger is axially displaced correspondingly to the introduced volume of the pressure flow and performs an outward movement. The inward movement is caused by a force acting from the outside in the opposite direction.

According to an advantageous further development, the working cylinder is characterized in that a first circumferential sealing ring is arranged in the cylinder interior between the first closure part and a cylinder tube inner wall of the cylinder tube at its first cylinder tube end at an axial distance from the first laser ring weld seam, said first circumferential sealing ring forming a first pressure-separated annular section, which is arranged between the first circumferential sealing ring and the first laser ring weld seam and/or in that a second circumferential sealing ring is arranged in the cylinder interior between the second closure part and a cylinder tube inner wall of the cylinder tube at its second cylinder tube end at an axial distance from the second laser ring weld seam, said second circumferential sealing ring forming a second pressure-separated annular section which is arranged between the second circumferential sealing ring and the second laser ring weld seam.

That means that according to this further development, a circumferential sealing ring is integrated upstream of at least one laser ring weld seam. Preferably, a circumferential sealing ring is arranged upstream of both laser ring weld seams. Hereinafter, the circumferential sealing ring is also referred to as an O-ring.

In the cylinder interior, the O-ring separates an annular section in front of the respective laser ring weld seam from the rest of the cylinder interior in a pressure-tight manner. It was surprisingly found that by the forming of a laser ring weld seam, the energy input per unit length can be set so low that a thermally sensitive O-ring is not damaged even in close proximity to the laser ring weld seam. Close proximity is understood to be an axial distance between the laser ring weld seam and the O-ring that is smaller than an internal cylinder tube diameter and, in a particularly preferred design, not more than the fourfold of a cylinder tube wall thickness.

The O-ring causes the separation of an annular section from the working pressure of the pressure medium. Thus, an axial section of the cylinder tube directly in front of and at the laser ring weld seam is not subject to the working pressure of the pressure medium from the inside and is therefore not subject to buckling load. In this way, a radial load on the laser ring weld seam, which would otherwise occur, is simultaneously avoided in an advantageous manner by a very simple means. Instead, only the axial load is applied. The axial load is based on the working pressure of the pressure medium acting on the base area of the respective closure part. Thus, a multi-axial load on the laser ring weld seam and consequentially a multi-axial material stress there are advantageously avoided.

At the same time, the upstream O-ring protects the at least one working chamber or, depending on the type of working cylinder with O-rings on both sides, both working chambers from contamination. Any emissions occurring during laser welding or particles that could detach from the coupling partners in the area of the laser weld seam are retained in the respective annular section by the O-ring before entering the working chamber.

According to another advantageous further development, the laser ring weld seams have a laser ring weld seam depth which has a ratio of 1.1 to 2.5 relative to a cylinder tube wall thickness.

If the laser ring weld does not run perpendicular through the cylinder tube wall, the laser ring weld seam depth is greater than the thickness of the cylinder tube wall.

Thus, the connection between the closure parts has a particularly advantageous higher stability, as the force transmission in the weld seam is distributed over a larger area and is therefore optimized.

This results in the further advantage that the tube wall thickness of the cylinder tube can be further reduced for specific applications.

In addition, according to this advantageous further development, it is also possible to already make the laser ring weld seam depth greater than the cylinder tube wall thickness by introducing the laser ring weld seam deeper into the closure part than the cylinder tube is thick. This results in a deeper weld seam root. Preferably, the laser ring weld depth is at least 1.2 times the cylinder tube thickness. It was surprisingly found that the structural changes in the closure part caused in this way increase the load-bearing capacity of the ring weld seams.

In general, the various advantageous further developments of the formation of the laser ring weld seams are not limited to specific cylinder types. In addition, different designs of the laser ring weld seams can also be combined for one and the same working cylinder.

The invention is described as an exemplary embodiment in more detail by means of the following figures. They show:

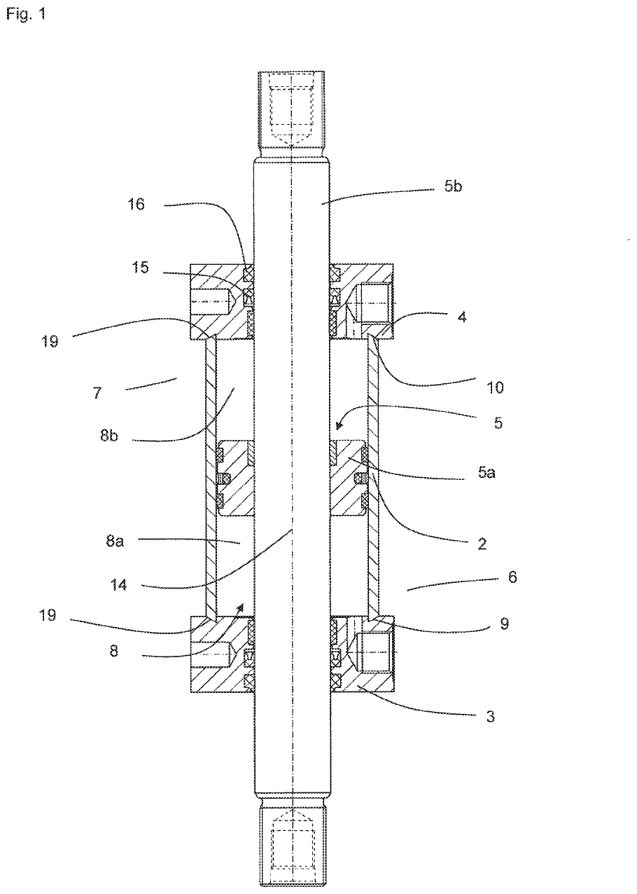

FIG. 1 Synchronized working cylinder (overview)

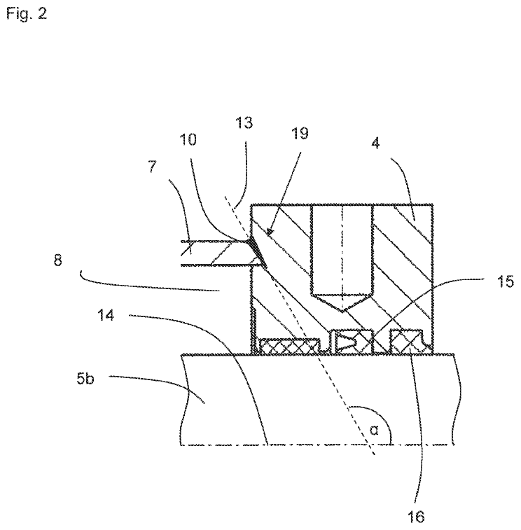

FIG. 2 Enlarged detail to FIG. 1 to show the concave receiving contour

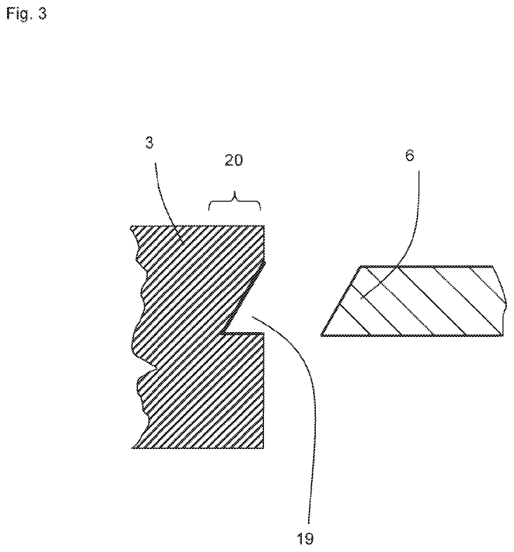

FIG. 3 Enlarged detail to FIG. 1 in exploded view

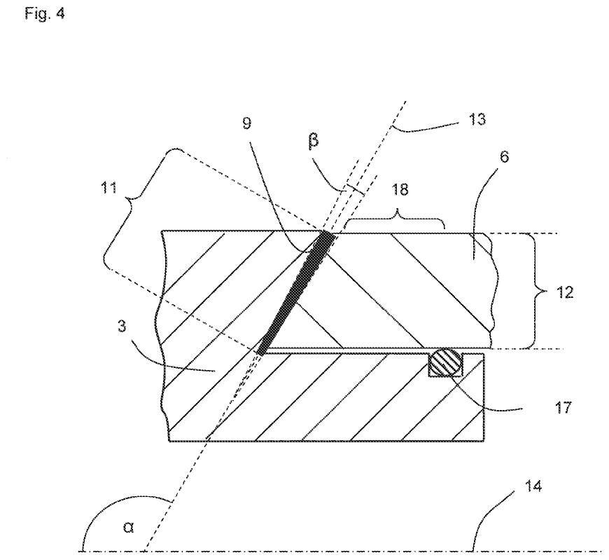

FIG. 4 Enlarged view of a laser weld seam to show the cross-section and the ring weld seam angle beta.

FIG. 1 shows an embodiment in which the working cylinder is designed as a synchronized working cylinder. In the synchronized working cylinder, both closure parts 3, 4, i.e., the first closure part 3 and the second closure part 4, are designed as guide closure parts. The piston 5a is arranged in the axially central area of the piston rod 5b, which is guided by both closure parts 3, 4. The piston 5a and piston rod 5b together form the piston 5.

The first cylinder tube end 6 is connected to the first closure part 3 by means of the negatively inclined first laser weld seam 9, and the second cylinder tube end is connected to the second closure part 4 by means of the negatively inclined second laser weld seam 10.

The two closure parts 3, 4 each have a concave receiving contour 19 into which the obliquely formed annular surfaces of the respective cylinder tube ends 6, 7 are inserted and welded there by means of the laser welding process.

FIG. 2 shows the embodiment of FIG. 1 in more detail.

Here, the second cylinder tube end 7 is already inserted into the wedge-shaped concave receiving contour 19 and welded to the second closure part 4 by means of the second circumferential laser ring weld seam 10.

The ring weld seam centre axis 13 and the main longitudinal axis 14 include the ring weld inclination angle alpha.

According to the invention, the ring weld seam angle alpha has an angle between 110 and 160 degrees, in the embodiment of about 120 degrees.

FIG. 3 shows the coupling partners according to FIG. 1 in a schematic exploded view. FIG. 3 shows the first cylinder tube end 6 and the first closure part 3 with the wedge-shaped concave receiving contour 19 before joining. The concave receiving contour 19 is designed to receive the first cylinder tube end 6 and to form a common contact surface with it, on which the first laser ring weld seam 9 is then arranged. FIG. 3 shows that the concave receiving contour 19 opens axially in the direction of the cylinder tube 2. Buckling forces acting radially from the inside on the cylinder tube 2 are thus absorbed in a positive-locking manner by a radial overlap 20. This is the radially outside section of the concave receiving contour 19.

FIG. 4 shows an enlarged laser weld seam. The first laser ring weld seam 9 shown here, between the first cylinder tube end 2 and the first closure part 3, shows an exemplary laser weld seam according to the present invention.

This first laser ring weld seam 9 has a ring weld seam depth 11 and a ring weld seam centre axis 13. In this embodiment, the ring weld seam depth 11 is greater than the cylinder tube wall thickness 12.

The laser weld seam has a slight conicity. If two tangents are put at the edge contour of the laser weld seam, they intersect and form a ring weld seam angle beta. The ring weld seam angle beta is preferably not greater than 15 degrees and in a particularly preferred design not greater than 10 degrees. The ring weld seam centre axis 13 is simultaneously the bisector of the ring weld seam angle beta and includes the ring weld seam inclination angle alpha with the main longitudinal axis 14. Furthermore, the ring weld seam centre axis 13 runs along the contact surface of the first cylinder tube end 6 and the first closure part 3. In this embodiment, the ring weld seam inclination angle alpha is 120 degrees.

FIG. 4 shows an embodiment with a circumferential sealing ring 17 (O-ring) located in front of the first laser ring weld seam 9, which separates the area in front of the first laser ring weld seam 9 from the pressure medium in a pressure-tight manner. This area is the pressure-separated annular section 18. Viewed axially, the pressure-separated annular section 18 is located between the sealing ring 17 (O-ring) and the first laser ring weld seam 9. In this annular section 18, radial forces do not act from inside on the cylinder tube at its first cylinder tube end 6. Thus, the first laser ring weld seam 9 is only subject to an axial tensile stress. Consequently, the cylinder tube 2 is not loaded with buckling forces in this area and the first laser ring weld seam 9 is relieved. In this embodiment, the sealing ring 17 (O-ring) is made of an elastic polymer. The heat input during laser welding remains sufficiently low to avoid damaging of the sealing ring 21 (O-ring) despite its close proximity to the first laser ring weld seam 9. It is also clear from FIG. 4 in conjunction with FIG. 3 that due to the narrow design of the laser ring weld seams 9, 10 according to the invention, the material in the area of the radial overlap 20 is only thermally stressed up to a small depth so that the corresponding closure part has to have only a small material thickness at the radial overlap 20.

### LIST OF REFERENCE NUMERALS

1 working cylinder
2 cylinder tube
3 first closure part
4 second closure part
5 piston unit
5a piston
5b piston rod
6 first cylinder tube end
7 second cylinder tube end
8 cylinder interior
8a first working chamber
8b second working chamber
9 first circumferential laser weld seam
10 second circumferential laser weld seam
11 ring weld seam depth
12 cylinder tube wall thickness
13 ring weld seam centre axis
14 main longitudinal axis
15 seal
20 guide
21 circumferential sealing ring
22 pressure-separated annular section
23 concave receiving contour
24 radial overlap
α ring weld seam inclination angle alpha
β ring weld seam angle beta

1-6. (canceled)

7. A working cylinder, comprising:
a cylinder tube, a first closure part, a second closure part and a piston unit;
said cylinder tube having a first cylinder tube end and a second cylinder tube end;
said first closure part being arranged at said first cylinder tube end and said second closure part being arranged at said second cylinder tube end, said cylinder tube and said first and second closure parts define a cylinder interior;
said piston unit defining at least one working chamber in said cylinder interior, said piston unit slidably passing through said first closure part;
said first closure part being joined to said cylinder tube in a positive-locking manner by a first circumferential laser ring weld seam, said second closure part being joined to said cylinder tube in a positive-locking manner by a second circumferential laser ring weld seam, and each of said laser ring weld seams defining a fluid-tight sealing plane;
at least one of said closure parts having an axially opening being circumferential concave receiving contour in which said cylinder tube engages, said receiving contour radially overlapping said cylinder tube, and a ring weld seam inclination angle thereof is 110 to 160 degrees.

8. The working cylinder according to claim 7, wherein said working cylinder is double-acting and is constructed as a differential working cylinder, said first closure part is constructed as a guide closure part and said second closure part is constructed as a bottom closure part, said first cylinder tube end is a guide-side cylinder tube end and said second cylinder tube end is a bottom-side cylinder tube end;
said piston unit includes a piston and a piston rod, said piston is arranged in said cylinder interior and separates said cylinder interior into a first working chamber constructed as a first piston rod working chamber and a second working chamber constructed as a piston rod working chamber, and said piston rod slidably passes through said guide closure part.

9. The working cylinder according to claim 7, wherein said working cylinder is double-acting and is constructed as a synchronized cylinder, said first closure part is constructed as a first guide closure part and said second closure part is constructed as a second guide closure part, said piston unit includes a piston and a piston rod, said piston is arranged in said cylinder interior and separates said cylinder interior into a first working chamber constructed as a first piston rod working chamber and a second working chamber constructed as a piston rod working chamber and said piston rod slidably passes through said guide closure part and said second guide closure part.

10. The working cylinder according to claim 7, wherein said working cylinder is single-acting and is constructed as a plunger cylinder, said first closure part is constructed as a guide closure part and said second closure part is constructed as a bottom closure part, said first cylinder tube end is a guide-side cylinder tube end and said second cylinder tube end is a bottom-side cylinder tube end, said piston unit is a plunger piston with a plunger, said plunger is arranged in said cylinder interior and defines a working chamber in said cylinder interior, and said plunger slidably passes through said guide closure part.

11. The working cylinder according to claim 7, wherein a first circumferential sealing ring is arranged at an axial distance from said first laser ring weld seam in said cylinder interior between said first closure part and a cylinder tube inner wall of said cylinder tube at said first cylinder tube end, said sealing ring defines a first pressure-separated annular section between said first circumferential sealing ring and said first laser ring weld seam, and/or a second circumferential sealing ring is arranged at an axial distance from said second laser ring weld seam in said cylinder interior between said second closure part and said cylinder tube inner wall at said second cylinder tube end, and said second circumferential sealing ring defines a second pressure-separated annular section arranged between said second circumferential sealing ring and said second laser ring weld seam.

12. The working cylinder according to claim 7, wherein each of said laser ring weld seams has a ring weld seam depth, said ring weld seam depth has a ratio of 1.1 to 2.5 relative to a cylinder tube wall thickness.
